(19) United States
(12) Patent Application Publication
(10) Pub. No.: US 2026/0358846 A1
(43) Pub. Date: Nov. 12, 2026

(54) LOW HEADROOM LINEAR CURRENT REGULATOR

(71) Applicant: Allegro MicroSystems, LLC, Manchester, NH (US)

(72) Inventors: Rajiv Damodaran Prabha, Nashua, NH (US); David Abramson, Stratham, NH (US); Martín Carrá, Ciudad Autónoma de Buenos Aires (AR); Roopesh Pyneni, Nashua, NH (US)

(73) Assignee: Allegro MicroSystems, LLC, Manchester, NH (US)

(21) Appl. No.: 19/205,003

(22) Filed: May 12, 2025

(51) Int. Cl. G05F 1/575; G05F 1/569; G05F 3/26

(52) U.S. Cl. CPC G05F 1/575; G05F 1/569; G05F 3/26

(57) ABSTRACT

Methods and apparatus for a current regulator receiving a current level setting at a node and an error amplifier having a first input coupled to the current level setting node and a second input, a first transistor having a first terminal coupled to a signal path for a regulated output current generated by the current regulator, a second terminal coupled to an output of the error amplifier, and a third terminal coupled to the second input of the amplifier. First and second FETs are configured to operate as a variable resistors for maintaining signal ratios at low current level settings.

### BACKGROUND

As is known in the art, linear current regulators are designed to provide a constant target current level output. Typical applications, such as LED drivers, have relatively low LED drive terminal voltage, as low as few 100 mVs, where lower voltages may be preferred to reduce power consumption. A resistor in series to the LED string, which may be internal or external to IC package, can be used to sense the output current to set it at a selected level with some level of precision. Linear current regulators are usually configured to maintain a current level even when the supply voltage level varies.

Linear current regulators typically supply a fixed target current on an output node. This current should ideally not depend on the external voltage on the supply pin. In practice, the output current deviates from the target outside the headroom of the regulator, i.e., the minimum required voltage needed to supply the target current. In known devices, such as a current sink regulator, there is a minimum voltage at the sink terminal level above which the current will be controlled and below which the current drops off. Reducing this voltage is desirable in modern ICs since the minimum voltage (headroom) is directly proportional to the power dissipated.

### SUMMARY

Example embodiments of the disclosure provide method and apparatus for a current regulator that includes one or more FETs used as a variable resistor to improve signal to error ratio for a programable wide range current regulator. In embodiments, the FET(s) can be used alone or in combination with a fixed series resistor to sense the true regulated output current. In some embodiments, a voltage is regulated across a FET to keep it in linear operation across an output current range to reduce mismatch between sense FET and reference FET.

In one aspect, a current regulator comprises: a node to receive a current level setting for the current regulator; an error amplifier having a first input coupled to the current level setting node and a second input; a first transistor having a first terminal coupled to a signal path for a regulated output current generated by the current regulator, a second terminal coupled to an output of the error amplifier; and a third terminal coupled to the second input of the amplifier; a first FET coupled to the current level setting node and to a reference amplifier configured to provide a regulated voltage to the first FET, wherein the first FET is configured to operate as a variable resistor for a first current range; and a second FET coupled to the first FET, to the error amplifier and to a current sense module for sensing the output current of the current regulator, wherein the second FET is configured to operate as a variable resistor for a second current range corresponding to an output current range of the current regulator.

A current regulator can further include one or more of the following features: the output current is sensed at a node between the second FET and a sense resistor, the first and second FETs are configured to maintain a constant voltage sense target V_{SNS} while the output current and resistances of the first and second FETs vary, a reference resistor coupled to the first FET and a sense resistor coupled to the second FET, a variable target voltage source coupled to an input of the reference amplifier, the second FET is not coupled to a sense resistor and the first FET is not coupled to a reference resistor, a current mirror for the output current to generate a sense current and a sensing amplifier to sense the sense current, the first FET and/or the second FET have a programmable size to maintain linear operation, the second FET is variable to maintain the current level setting, the variable target voltage source is variable to maintain the current level setting, and/or the node is configured to receive a current level setting for the current regulator.

In another aspect, a method of regulating current comprises: providing a node to receive a current level setting for a current regulator; providing an error amplifier having a first input coupled to the current level setting node and a second input; providing a first transistor having a first terminal coupled to a signal path for a regulated output current generated by the current regulator, a second terminal coupled to an output of the error amplifier; and a third terminal coupled to the second input of the amplifier; providing a first FET coupled to the current level setting node and to a reference amplifier configured to provide a regulated voltage to the first FET, wherein the first FET is configured to operate as a variable resistor for a first current range; and providing a second FET coupled to the first FET, to the error amplifier and to a current sense module for sensing the output current of the current regulator, wherein the second FET is configured to operate as a variable resistor for a second current range corresponding to an output current range of the current regulator.

A method can further include one or more of the following features: the output current is sensed at a node between the second FET and a sense resistor, the first and second FETs are configured to maintain a constant voltage sense target V_{SNS} while the output current and resistances of the first and second FETs vary, a reference resistor coupled to the first FET and a sense resistor coupled to the second FET, a variable target voltage source coupled to an input of the reference amplifier, the second FET is not coupled to a sense resistor and the first FET is not coupled to a reference resistor, a current mirror for the output current to generate a sense current and a sensing amplifier to sense the sense current, the first FET and/or the second FET have a programmable size to maintain linear operation, the second FET is variable to maintain the current level setting, the variable target voltage source is variable to maintain the current level setting, and/or the node is configured to receive a current level setting for the current regulator.

### DESCRIPTION OF THE DRAWINGS

The foregoing features may be more fully understood from the following description of the drawings. The drawings aid in explaining and understanding the disclosed technology. Since it is often impractical or impossible to illustrate and describe every possible embodiment, the provided figures depict one or more illustrative embodiments. Accordingly, the figures are not intended to limit the scope of the broad concepts, systems and techniques described herein. Like numbers in the figures denote like elements.

FIG. 1 is a block diagram of an example linear current regulator having enhanced headroom performance in accordance with example embodiments of the disclosure;

FIG. 2 shows a circuit for a prior art current regulator;

FIG. 3 shows a circuit for a prior art current regulator;

FIG. 4 shows an example current regulator having enhanced headroom performance in accordance with example embodiments of the disclosure;

FIG. 5A shows an example implementation of the current sensing for the regulator of FIG. 4;

FIG. 5B shows a further example implementation of the current sensing for the regulator of FIG. 4;

FIG. 6A shows R_{SNS} versus current for an example embodiment of a low headroom regulator where the value of the sense resistor R_{SNS} varies from a maximum at the minimum current I_{MIN} to a minimum at the maximum current I_{MAX} and a prior art regulator; and

FIG. 6B shows a sense voltage vs output current for an example embodiment of a low headroom regulator where the sense voltage V_{SNS} remains constant from minimum current I_{MIN} to maximum current I_{MAX} and a prior art regulator.

### DETAILED DESCRIPTION

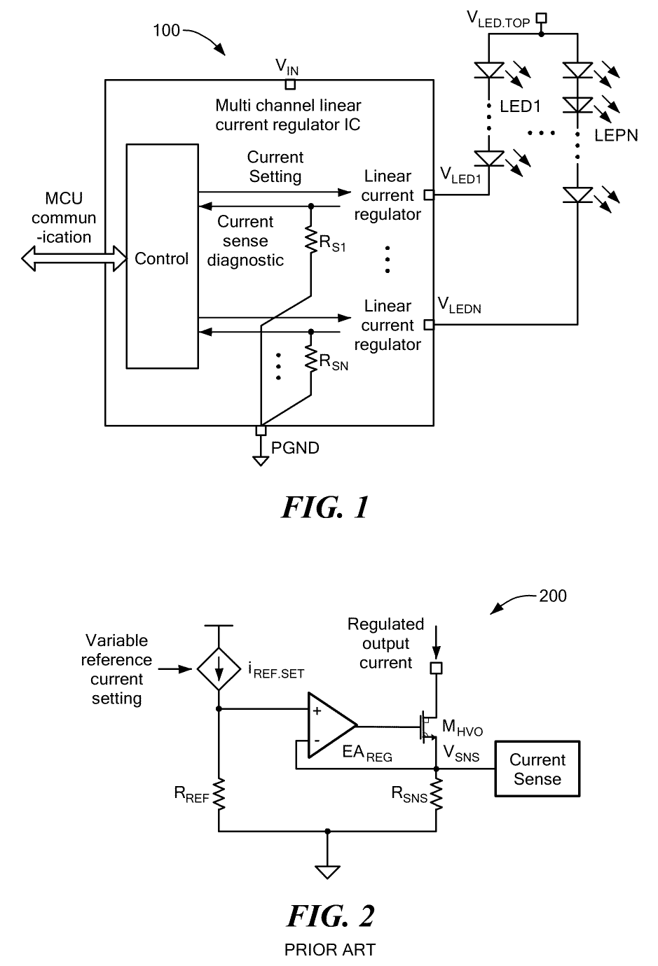

FIG. 1 is a high level block diagram of an example multi-channel linear current regulator 100 having enhanced headroom functionality in accordance with example embodiments of the disclosure. In the illustrated embodiment, the current regulator 100 is implemented in an IC package having an example pinout. The current regulator 100 is configured to maintain a current level to one or more LED arrays LED1, …LEDN.

The regulator 100 may receive a supply voltage at terminal VIN, such as from a battery, that energizes components of the regulator, which can be provided as an IC package with the illustrated pinout configuration. Terminal V_{LED1} is configured for connection to a cathode of a first LED array LED1 and terminal V_{LEDN} is configured to connect to the Nth LED array LEDN.

Any practical number of LED arrays can be connected to the regulator. An anode of the LED arrays can be coupled to a voltage signal at VLED.TOP, for example, or may be provided by the regulator.

Each LED array path has a sense resistor, R_{S1} for the 1^{st} LED array and R_{SN} for the Nth LED array, in series with it for sensing current levels in a given application, such as energizing LEDs in an automobile headlamp

In embodiments, the regulator 100 can be coupled to a remote device, such as a master control unit (MCU), that controls current regulation parameters. The MCU may provide a current level setting for operation of the LED arrays and receive an actual sensed current level from the regulator 100 which may be used for diagnostic functionality.

While example embodiments of the disclosure are shown and described in conjunction with current regulators for LED loads, it is understood that embodiments of the disclosure are applicable to regulators in general in which low headroom due to low supply voltages is present.

FIG. 2 shows a portion of a prior art current regulator circuit 200 that senses the regulated output current by sensing the voltage across a fixed sense resistor R_{SNS} using a closed loop error amplifier EA_{REG} configuration with a FET M_{HVO}, and the sense resistor R_{SNS}. The output current is sensed by measuring the voltage v_{SNS} across the sense resistor R_{SNS}. The regulator output current setting can be changed by changing the input of error amplifier EA_{REG} set by reference current i_{REF.SET} flowing into the reference resistor R_{REF}.

A disadvantage of this circuit is that the regulated voltage V_{SNS} changes with target current and when the current is low, the V_{SNS} signal level is low. As the V_{SNS} signal decreases, the signal to error ratio of the regulated current decreases making it difficult to obtain an accurate current measurement. The error in the loop is mainly due to the offset of the amplifier and resistance mismatch all of which vary with temperature and fabrication process. As will be readily appreciated, as the input signal levels decrease, the amplifier offset is more difficult to remove. Even after compensating for the process variations with trimming of the device, temperature variations can cause significant inaccuracies in the output current measurement.

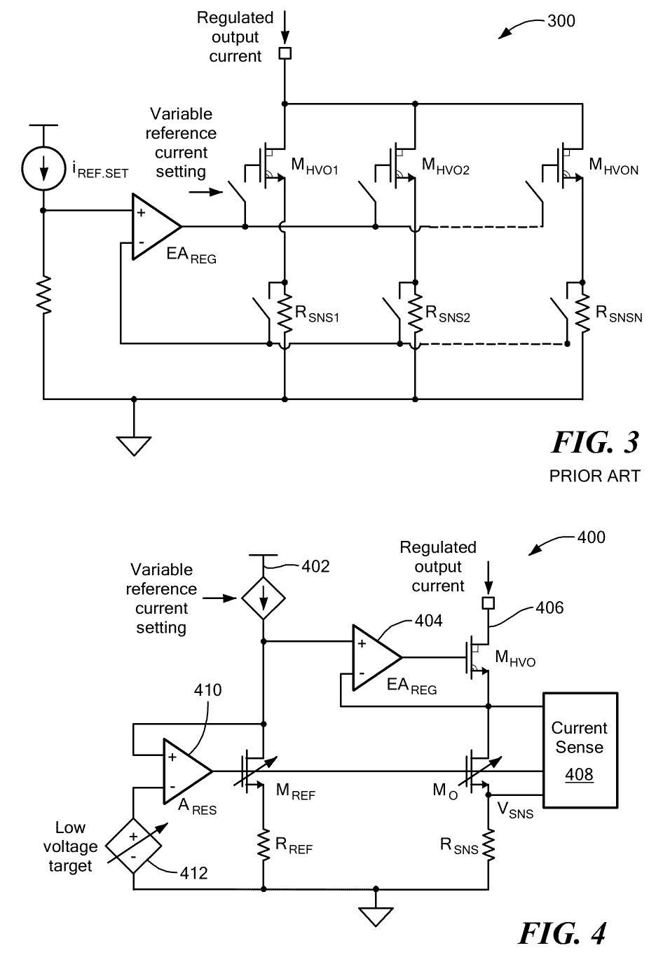

In other known configurations, additional pairs of FETs and sense resistor legs can be switched in vary the current. While this may address reduction of signal to error ratio with lower current, there is no single point at which to measure current which increases circuit complexity. For example, FIG. 3 shows a known current regulator 300 having a series of legs with FETs M_{HVO1}, M_{HVO2}, …M_{HVON} coupled to respective sense resistors R_{SNS1}, R_{SNS2}, R_{SNSN}. The gates of the FETs M_{HVOx} are selectively coupled to the output of an error amplifier EA_{REG} to increase or decrease current levels via switches controlled by a variable reference current setting. In this configuration, a constant V_{SNS} target is maintained. The number of active resistive legs is selected to vary the current level to address the issue of reduction of signal to error ratio with lower current. However, it is challenging to accurately control the switches to achieve desired functionality and difficult to sense actual current level since there is no single series element to make the measurement.

FIG. 4 shows an example current regulation circuit 400 with enhanced headroom performance in accordance with illustrative embodiments of the disclosure. A variable reference current 402 is injected in the resistor or MREF FET. A regulated output current 406 to be sensed is coupled to a transistor shown as FET M_{HVO}. A gate of FET M_{HVO} is coupled to the output of the error amplifier 404 with the FET coupled in a feedback arrangement. A FET M_{O} and a sense resistor R_{SNS} are coupled in series to generate a sense voltage V_{SNS} therebetween for sensing by a current sense module 408. In the illustrated embodiment, the negative input of the error amplifier 404 is coupled to a node between FET M_{HVO} and FET M_{O} with the node also coupled to the current sense module 408.

A reference amplifier A_{RES} 410 has a first input coupled to the variable current reference 402 and a second input coupled to a variable voltage reference 412. In the illustrated embodiment, a reference FET M_{REF} and a reference resistor R_{REF} are coupled in series and the output of the reference amplifier 410 is coupled to the gate of the reference FET M_{REF} and the gate of FET M_{O}. The reference FET M_{REF} is coupled in a feedback relationship with the reference amplifier 410. The reference FET M_{REF}, due to the target voltage 412, causes the FET to operate as a variable resistor. If the FETs M_{REF} and M_{O} remain in linear region, in which the impedance is similar to a resistor, across the current range the circuit does not suffer from reduction of signal to error ratio with lower current level settings as voltage across it set at constant target level. In addition, the M_{O} FET and/or the sense resistor R_{SNS} can serve as the sensing element. In embodiments, the low voltage target or the sizes of the M_{REF} or M_{O} FETS are selectable across current range to maintain the FETs in linear region over expected operating conditions.

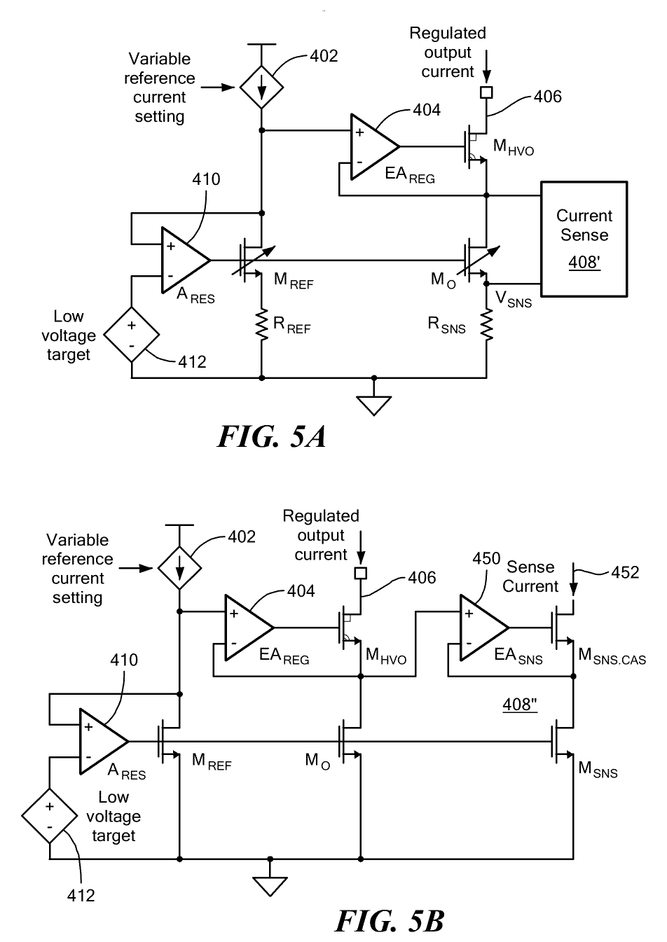

FIG. 5A shows an example current sense implementation 408’ for regulator of FIG. 4 with explicit impedances for R_{SNS} and R_{REF} where the current sensor module detects current level at a node between FET M_{O} and the sense resistor R_{SNS}. The explicit impedances for R_{SNS} and R_{REF} can improve current regulation accuracy at the expense of area since resistors match better than FETs.

FIG. 5B shows an example current sense implementation 408” for regulator of FIG. 4 without resistor R_{SNS} and R_{REF} where the current sense module senses a mirrored copy of the regulator output current. In this configuration, the circuit does not have any fixed resistors for sensing current levels. The regulator includes a sense amplifier 450 having a first input coupled to the node between M_{HVO} and M_{O} FETs and an input coupled in a feedback arrangement with FET M_{SNS.CAS}. In the illustrated embodiment, the output of reference amplifier 410 is coupled to the gate of FET M_{SNS} in addition to the gates of M_{O} and M_{REF}. FET M_{SNS.CAS} and FET M_{SNS} are coupled in series to receive the sense current 452 and provide a circuit to sense current in conjunction with the sense amplifier 450 without R_{SNS} and R_{REF} in FIG. 4.

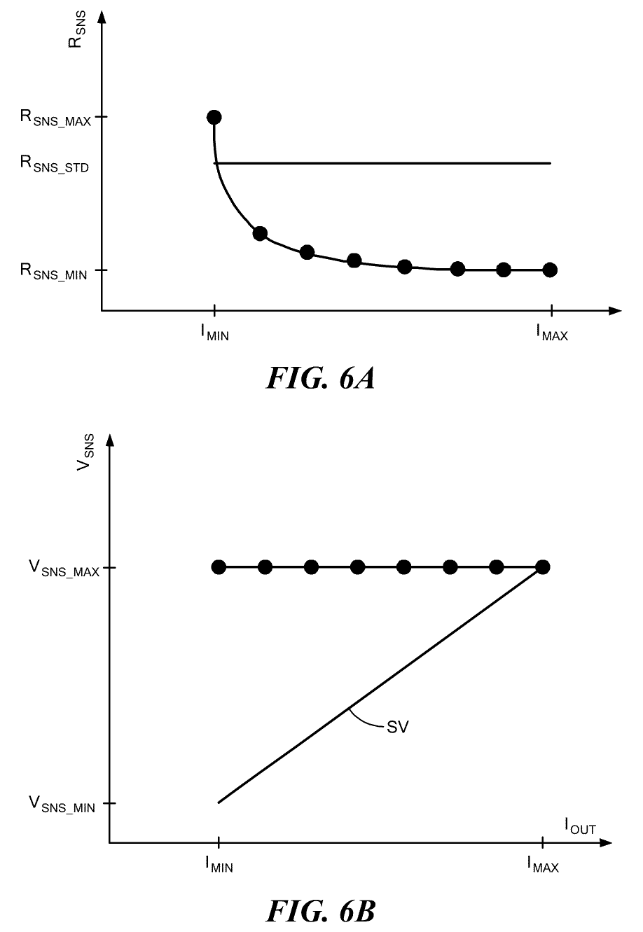

FIG. 6A shows R_{SNS} versus current across a current range of I_{MIN} and I_{MAX} for an example embodiment of a low headroom regulator, such as the regulator shown in FIG. 4. In a conventional regulator, the sense resistance R_{SNS_STD} is fixed. In contrast, for a FIG. 4 regulator implementation having variable resistance FETs, the value of the sense resistance R_{SNS} varies from a maximum at the minimum current I_{MIN} to a minimum at the maximum current I_{MAX}. As can be seen, the resistance decreases in a non-linear way inversely proportional to current.

FIG. 6B shows a sense voltage vs output current. In a conventional regulator, the sense voltage SV is at a minimum at the minimum current level and increases linearly until reaching the maximum current level. As will be appreciated, at minimum current levels and a corresponding low V_{SNS} in a conventional regulator, the signal of interest may get swamped by the amplifier offset, temperature changes, etc. In contrast, for a FIG. 4 implementation, the target sense voltage V_{SNS} remains constant at V_{SNS_MAX} from minimum current I_{MIN} to maximum current I_{MAX} since the resistance of the FETs vary across the current range, as shown in FIG. 6A.

Having described preferred embodiments, it will now become apparent to one of ordinary skill in the art that other embodiments incorporate their concepts may be used. Elements of different embodiments described herein may be combined to form other embodiments not specifically set forth above. Various elements, which are described in the context of a single embodiment, may also be provided separately or in any suitable sub combination. Other embodiments not specifically described herein are also within the scope of the following claims. All references cited herein are hereby incorporated herein by reference in their entirety.

It is felt therefore that these embodiments should not be limited to disclosed embodiments, but rather should be limited only by the spirit and scope of the appended claims.

What is claimed is:

1. A current regulator, comprising
a node to receive a current level setting for the current regulator;
an error amplifier having a first input coupled to the current level setting node and a second input;
a first transistor having a first terminal coupled to a signal path for a regulated output current generated by the current regulator, a second terminal coupled to an output of the error amplifier; and a third terminal coupled to the second input of the amplifier;
a first FET coupled to the current level setting node and to a reference amplifier configured to provide a regulated voltage to the first FET, wherein the first FET is configured to operate as a variable resistor for a first current range; and
a second FET coupled to the first FET, to the error amplifier and to a current sense module for sensing the output current of the current regulator, wherein the second FET is configured to operate as a variable resistor for a second current range corresponding to an output current range of the current regulator.

2. The current regulator according to claim 1, wherein the output current is sensed at a node between the second FET and a sense resistor.

3. The current regulator according to claim 1, wherein the first and second FETs are configured to maintain a constant voltage sense target V_{SNS} while the output current and resistances of the first and second FETs vary.

4. The current regulator according to claim 1, further including a reference resistor coupled to the first FET and a sense resistor coupled to the second FET.

5. The current regulator according to claim 1, further including a variable target voltage source coupled to an input of the reference amplifier.

6. The current regulator according to claim 1, wherein the second FET is not coupled to a sense resistor and the first FET is not coupled to a reference resistor.

7. The current regulator according to claim 6, further including a current mirror for the output current to generate a sense current and a sensing amplifier to sense the sense current.

8. The current regulator according to claim 1, wherein the first FET and/or the second FET have a programmable size to maintain linear operation.

9. The current regulator according to claim 1, wherein the second FET is variable to maintain the current level setting.

10. The current regulator according to claim 5, wherein the variable target voltage source is variable to maintain the current level setting.

11. The current regulator according to claim 1, wherein the node is configured to receive a current level setting for the current regulator.

12. A method of regulating current, comprising:
providing a node to receive a current level setting for a current regulator;
providing an error amplifier having a first input coupled to the current level setting node and a second input;
providing a first transistor having a first terminal coupled to a signal path for a regulated output current generated by the current regulator, a second terminal coupled to an output of the error amplifier; and a third terminal coupled to the second input of the amplifier;
providing a first FET coupled to the current level setting node and to a reference amplifier configured to provide a regulated voltage to the first FET, wherein the first FET is configured to operate as a variable resistor for a first current range; and
providing a second FET coupled to the first FET, to the error amplifier and to a current sense module for sensing the output current of the current regulator, wherein the second FET is configured to operate as a variable resistor for a second current range corresponding to an output current range of the current regulator.

13. The method according to claim 12, wherein the output current is sensed at a node between the second FET and a sense resistor.

14. The method according to claim 12, wherein the first and second FETs are configured to maintain a constant voltage sense target V_{SNS} while the output current and resistances of the first and second FETs vary.

15. The method according to claim 12, further including employing a reference resistor coupled to the first FET and a sense resistor coupled to the second FET.

16. The method according to claim 12, further including employing a variable target voltage source coupled to an input of the reference amplifier.

17. The method according to claim 12, wherein the second FET is not coupled to a sense resistor and the first FET is not coupled to a reference resistor.

18. The method according to claim 17, further including employing a current mirror for the output current to generate a sense current and a sensing amplifier to sense the sense current.

19. The method according to claim 12, wherein the first FET and/or the second FET have a programmable size to maintain linear operation.

20. The method according to claim 12, wherein the second FET is variable to maintain the current level setting.
